(19) United States
(12) Patent Application Publication
(10) Pub. No.: US 2020/0003634 A1
(43) Pub. Date: Jan. 2, 2020

(54) SENSOR SHEET, CAPACITIVE SENSOR, AND METHOD FOR MANUFACTURING SENSOR SHEET

(71) Applicant: Sumitomo Riko Company Limited, Aichi (JP)

(72) Inventors: Hikaru HAYASHI, Aichi (JP); Tomohiro FUJIKAWA, Aichi (JP)

(73) Assignee: Sumitomo Riko Company Limited, Aichi (JP)

(21) Appl. No.: 16/568,257

(22) Filed: Sep. 12, 2019

Related U.S. Application Data
(63) Continuation of application No. PCT/JP2018/022759, filed on Jun. 14, 2018.

(30) Foreign Application Priority Data
Jun. 29, 2017 (JP) 2017-127709

(51) Int. Cl. G01L 1/14; G01B 7/16; G01D 5/241; G01B 7/28; G01B 7/06; G01L 5/00

(52) U.S. Cl. CPC G01L 1/142; G01B 7/22; G01L 5/0014; G01B 7/28; G01B 7/08; G01D 5/241

(57) ABSTRACT

Provided is a sensor sheet, a capacitive sensor, and a method for manufacturing sensor sheet with which it is possible to suppress changes in capacitance due to an arrangement state. This sensor sheet (1) includes a pair of electrode layers (1X-4X, 1Y-4Y), constraint layers (32, 42) that regulate the surface-direction expansion and contraction of the electrode layers (1X-4X, 1Y-4Y), a plurality of detection parts (A (1, 1)-A (4, 4)) disposed in portions where the pair of electrode layers (1X-4X, 1Y-4Y) is overlapped when viewed from the lamination direction, and non-detection parts (G) disposed between the plurality of detection parts (A (1, 1)-A (4, 4)). In a no-load state, the constraint layers (32, 42) are disposed in at least some of the plurality of detection parts (A (1, 1)-A (4, 4)), and gaps (g) are partitioned in at least some of the non-detection parts (G).

### CROSS-REFERENCE TO RELATED APPLICATION

This application is a continuation application of International Application number PCT/JP2018/022759, filed on Jun. 14, 2018, which claims the priority benefit of Japan Patent Application No. 2017-127709, filed on Jun. 29, 2017. The entirety of each of the above-mentioned patent applications is hereby incorporated by reference herein and made a part of this specification.

### BACKGROUND OF THE DISCLOSURE

### Technical Field

The disclosure relates to a sensor sheet, a capacitive sensor equipped with a sensor body obtained from the sensor sheet, and a method for manufacturing the sensor sheet.

### Related Art

In patent literature 1, a shape recognition device equipped with a pressure-sensitive sheet, a row-electrode sheet, and a column-electrode sheet is disclosed. The column-electrode sheet is laminated on the front side of the pressure-sensitive sheet, and the row-electrode sheet is laminated on the rear side of the pressure-sensitive sheet. The row-electrode sheet and the column-electrode sheet respectively include a plurality of parallel electrodes. A plurality of pressure-sensitive parts is fixed to the pressure-sensitive sheet. When viewed from the front side, the plurality of pressure-sensitive parts is disposed in portions where the parallel electrodes of the row-electrode sheet and the parallel electrodes of the column-electrode sheet are overlapped. The shape recognition device detects changes in capacitance of the plurality of pressure-sensitive parts.

### LITERATURE OF RELATED ART

### Patent Literature

Patent literature 1: Japanese Laid-open No. 2000-321013

### SUMMARY

### Problems to be Solved

The capacitive sensor described in patent literature 1 has a flat-plate shape. On the other hand, an arrangement surface (human forearm) of the capacitive sensor has a curved-surface shape. Therefore, the capacitive sensor is disposed in a state of being curved with respect to the original shape. However, the plurality of pressure-sensitive parts is fixed on the pressure-sensitive sheet. Therefore, the pressure-sensitive parts deform easily when the capacitive sensor is disposed on the arrangement surface. The capacitance changes easily when the pressure-sensitive parts deform. Accordingly, in a case of the capacitive sensor described in patent literature 1, the capacitance detected from the pressure-sensitive parts changes easily due to the arrangement state of the capacitive sensor. Therefore, the purpose of the disclosure is to provide a sensor sheet, a capacitive sensor, and a method for manufacturing sensor sheet with which it is possible to suppress changes in capacitance due to an arrangement state.

### Means to Solve Problems

In order to solve the above problem, the sensor sheet of the disclosure includes: a pair of electrode layers disposed to be spaced apart in the lamination direction; constraint layers that regulate the surface-direction expansion and contraction of the electrode layers; a plurality of detection parts disposed in portions where the pair of electrode layers is overlapped when viewed from the lamination direction; and non-detection parts disposed between the plurality of detection parts when viewed from the lamination direction; in a no-load state, the constraint layers are disposed in at least some of the plurality of detection parts, and gaps are partitioned in at least some of the non-detection parts.

Here, the “no-load state” refers to the state before the sensor sheet (sometimes a sensor body as described later) is disposed on a prescribed arrangement surface and the state in which no load is applied to the sensor sheet.

In addition, in order to solve the above problems, the capacitive sensor of the disclosure includes a sensor body of the sensor sheet. In addition, in order to solve the above problem, the method for manufacturing sensor sheet of the disclosure has a laminate production process for producing a laminate which has the dielectric layers, the constraint layers and a mold-release base material by attaching the inside adhesive layers of the constraint layers to the dielectric layers and temporally attaching the outside adhesive layers of the constraint layers to the mold-release base material.

### Effect

According to the sensor sheet of the disclosure, the gaps are partitioned in at least some of the non-detection parts. Therefore, when the sensor sheet is disposed on the arrangement surface, the non-detection parts can be made to deform prior to the detection parts following the shape of the arrangement surface. Accordingly, the detection parts can be suppressed from deforming due to the arrangement state of the sensor sheet. Thus, capacitance of the detection parts can be suppressed from changing due to the arrangement state of the sensor sheet.

In addition, according to the sensor sheet of the disclosure, the constraint layers are disposed in at least some of the detection parts. Therefore, when the sensor sheet is disposed on the arrangement surface, the surface-direction expansion and contraction (at least one of expansion and contraction) of the electrode layers can be regulated. Accordingly, electrode area, that is, capacitance of the detection parts can be suppressed from changing due to the arrangement state of the sensor sheet.

In addition, according to the capacitive sensor of the disclosure, similar to the sensor sheet of the disclosure, capacitance of the detection parts can be suppressed from changing due to the arrangement state of the sensor body. In addition, according to the method for manufacturing sensor sheet of the disclosure, the sensor sheet of the disclosure can be manufactured easily. In addition, the laminate includes the mold-release base material. Therefore, handling (for example, transferring, setting on a jig or a machine, or the like) of the laminate after the laminate production process, that is, handling of the dielectric layers and the constraint layers is simple.

### BRIEF DESCRIPTION OF THE DRAWINGS

FIG. 1 is a transparent top view of a sensor sheet of a first embodiment.

FIG. 2 is an II-II direction cross-sectional view of FIG. 1.

FIG. 3 is an enlarged view in a frame III of FIG. 2.

FIG. 4 is an exploded perspective view of a front side electrode unit of the sensor sheet of the first embodiment.

FIG. 5 is an exploded perspective view of a rear side electrode unit of the sensor sheet of the first embodiment.

(a) of FIG. 6 is a vertical cross-sectional view of a laminate. (b) of FIG. 6 is a vertical cross-sectional view of a combination of the laminate (without a rear side mold-release base material) and the rear side electrode unit. (c) of FIG. 6 is a vertical cross-sectional view of a combination of the laminate (without the rear side mold-release base material and a front side mold-release base material), the rear side electrode unit, and the front side electrode unit.

FIG. 7 is a vertical cross-sectional view of the sensor sheet of the first embodiment in an arrangement state.

FIG. 8 is an enlarged view in a frame VIII of FIG. 7.

(a) of FIG. 9 is a sensor body (No. 1) cut off from the sensor sheet shown in FIG. 1. (b) of FIG. 9 is a sensor body (No. 2) cut off from the sensor sheet shown in FIG. 1.

FIG. 10 is a vertical cross-sectional view of the vicinity of non-detection parts of a sensor sheet of a second embodiment.

FIG. 11 is a transparent top view of a sensor sheet of a third embodiment.

(a) of FIG. 12 is an arrangement state diagram of a sensor sheet of another embodiment (No. 1). (b) of FIG. 12 is an arrangement state diagram of a sensor sheet of another embodiment (No. 2).

### DESCRIPTION OF THE EMBODIMENTS

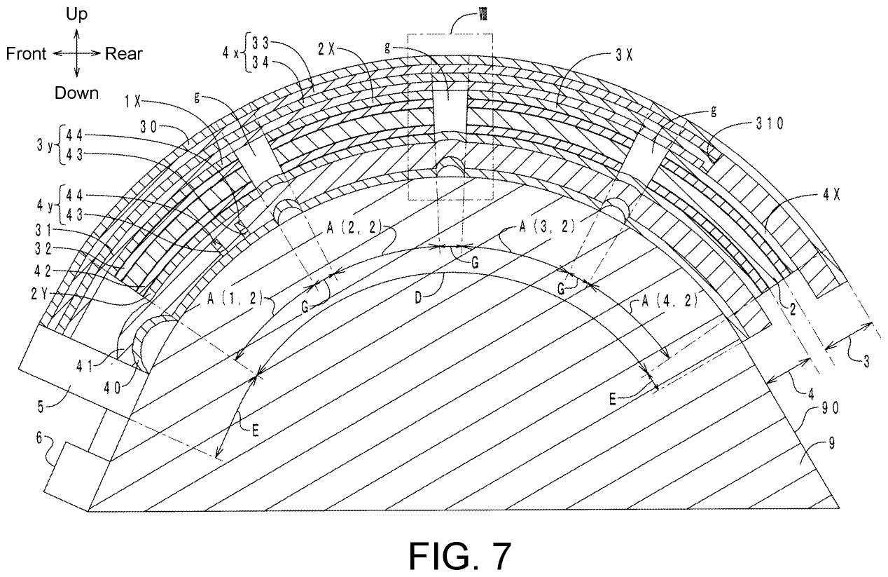

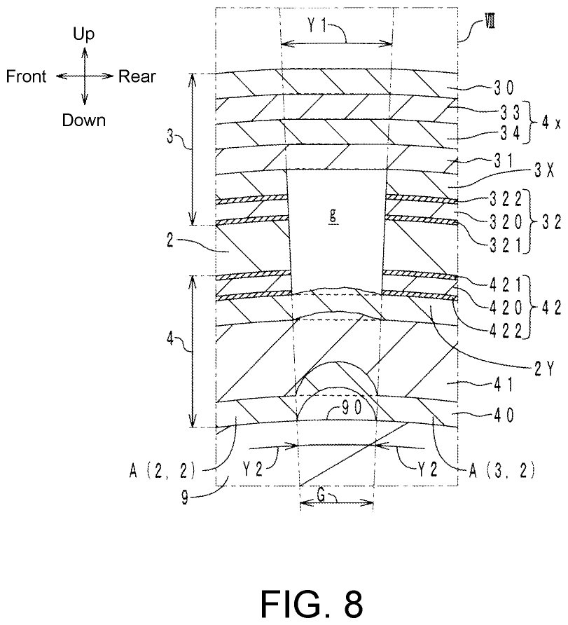

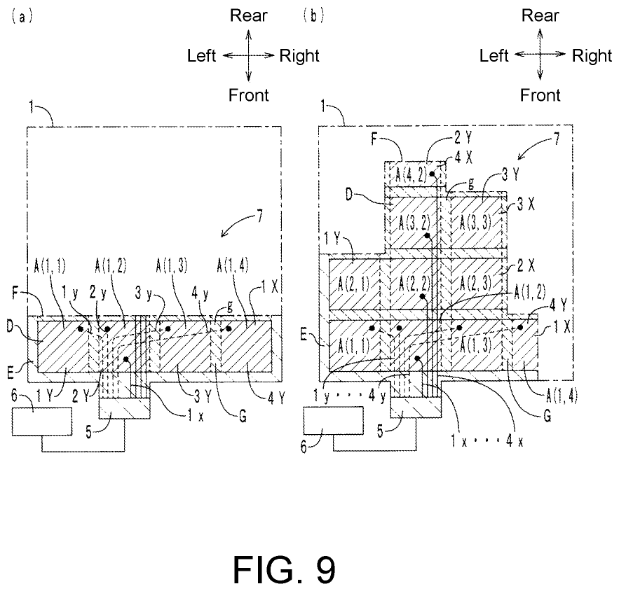

Embodiments of a sensor sheet, a capacitive sensor, and a method for manufacturing sensor sheet of the disclosure are described below. In the following diagrams (except FIG. 7, FIG. 8, (a) of FIG. 12, (b) of FIG. 12 illustrating an arrangement state), the vertical direction corresponds to the “lamination direction” of the disclosure, and at least one direction of the horizontal directions (direction orthogonal to the lamination direction) corresponds to the “surface direction” of the disclosure.

### First Embodiment

### Configuration of Sensor Sheet

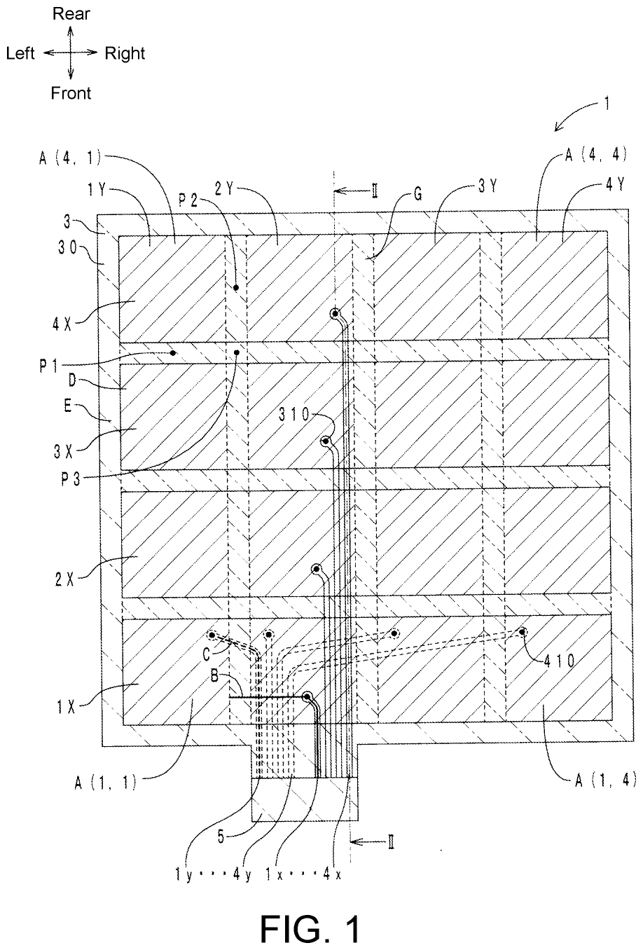

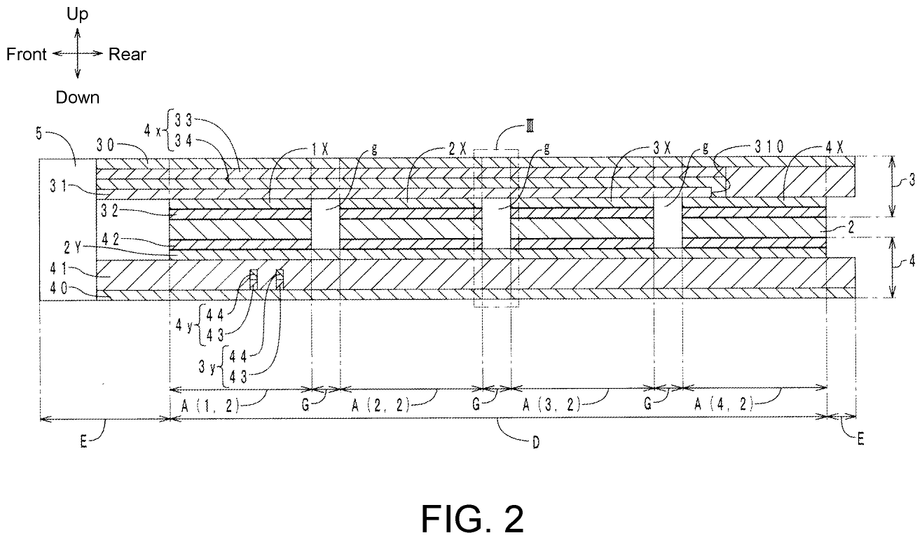

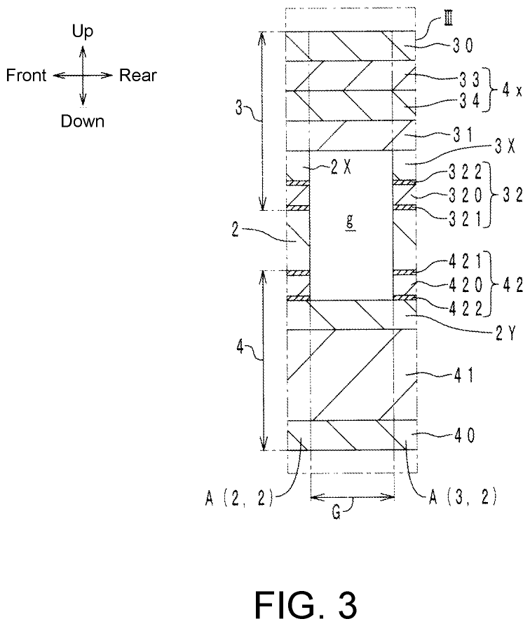

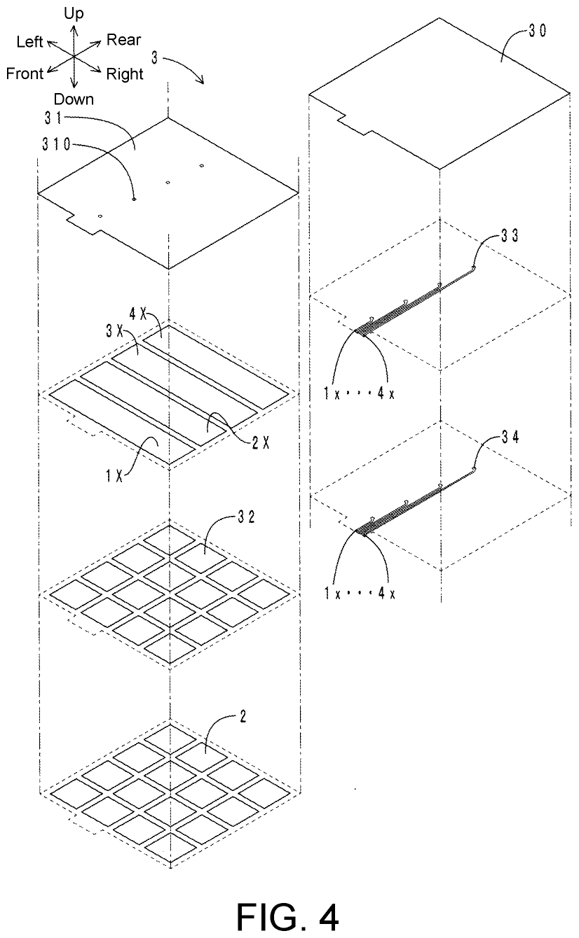

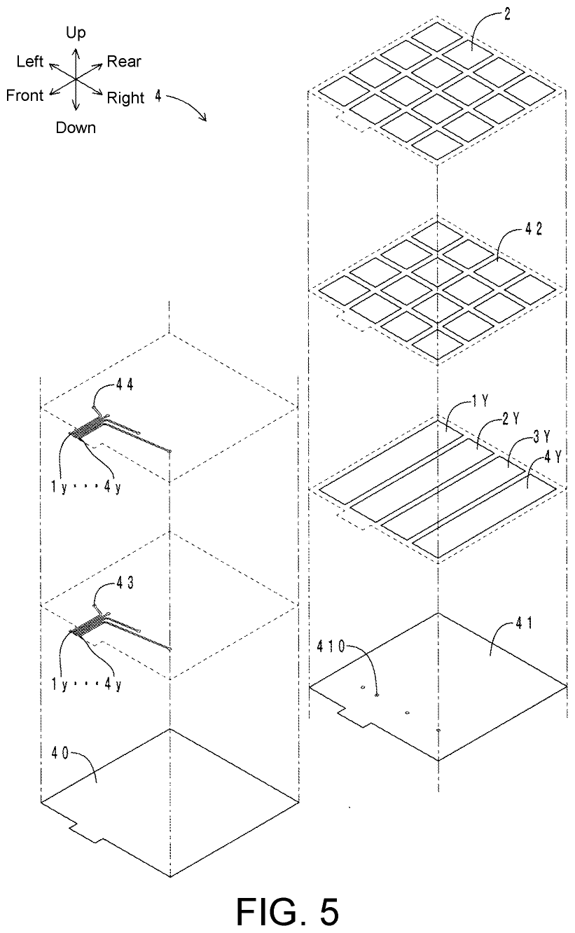

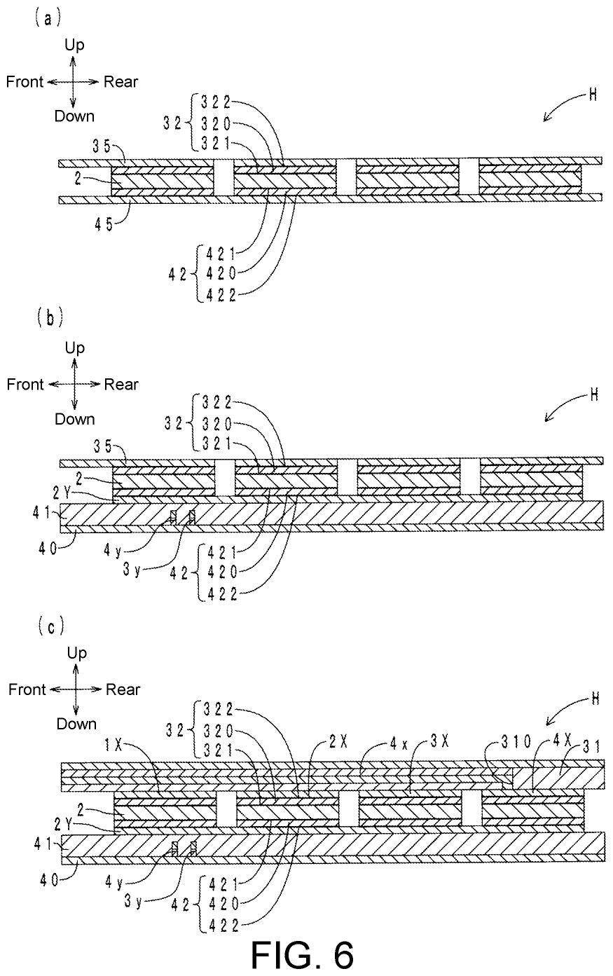

Firstly, a configuration of the sensor sheet of this embodiment is described. In FIG. 1, a transparent top view of the sensor sheet of the embodiment is shown. In FIG. 2, an II-II direction cross-sectional view of FIG. 1 is shown. In FIG. 3, an enlarged view in a frame III of FIG. 2 is shown. In FIG. 4, an exploded perspective view of a front side electrode unit of the sensor sheet is shown. In FIG. 5, an exploded perspective view of a rear side electrode unit of the sensor sheet is shown. Besides, in FIG. 1, the rear side electrode unit is shown by dotted lines.

As shown in FIG. 1-FIG. 5, a sensor sheet 1 includes 16 dielectric layers 2, a front side electrode unit 3, a rear side electrode unit 4, and a connector 5. The connector 5 is included in the concept of “extraction part” of the disclosure. In a no-load state (a state in which the sensor sheet 1 (sometimes a sensor body as described later) is disposed on a prescribed arrangement surface, and no load is applied to the sensor sheet 1), the sensor sheet 1 has a flat-plate shape.

### Dielectric Layer 2 and Front Side Electrode Unit 3

The 16 dielectric layers 2 are made from urethane foam and have a shape of individual pieces. As shown in FIG. 2 and FIG. 3, the front side electrode unit 3 is disposed on the upper side (one side in the lamination direction) of the 16 dielectric layers 2. As shown in FIG. 4, the front side electrode unit 3 includes a front side base material 30, four front side wiring layers 1x-4x, a front side insulating layer 31, four front side electrode layers 1X-4X, and 16 front side constraint layers 32. The four front side electrode layers 1X-4X are included in the concept of “electrode layer” of the disclosure. The 16 front side constraint layers 32 are included in the concept of “constraint layer” of the disclosure.

The front side base material 30 is made of textile having stretchability such as Lycra Taffeta (“Lycra” is a registered trademark of Invista Technologies SARL) made by Toray Opelontex Co., Ltd. and is sheet-shaped. As shown in FIG. 4, on the lower side of the front side base material 30, the front side wiring layers 1x-4x, the front side insulating layer 31, the front side electrode layers 1X-4X, and the front side constraint layers 32 are disposed from the upper side toward the lower side (the other side in the lamination direction).

The front side insulating layer 31 is sheet-shaped. The front side insulating layer 31 contains urethane rubber and titanium oxide particles used as an anti-blocking agent. As shown in FIG. 4, four front side through holes 310 are drilled in the front side insulating layer 31. The four front side through holes 310 vertically face the four front side electrode layers 1X-4X. As shown in FIG. 1, when viewed from the upper side, the four front side through holes 310 are lined up in the front-rear direction to overlap on the rear side electrode layer 2Y of the second column from the left (the rear side electrode layer closest to the connector 5).

As shown in FIG. 4, the four front side wiring layers 1x-4x are disposed on the upper surface of the front side insulating layer 31. Each of the front side wiring layers 1x-4x has a first wiring layer 33 and a second wiring layer 34. The first wiring layer 33 is formed on the lower surface of the front side base material 30. The first wiring layer 33 contains acrylic rubber and silver powder. The second wiring layer 34 is formed on the lower surface of the first wiring layer 33. The second wiring layer 34 contains acrylic rubber and conductive carbon black.

The four front side electrode layers 1X-4X are disposed on the lower surface of the front side insulating layer 31. Each of the front side electrode layers 1X-4X contains acrylic rubber and conductive carbon black. Each of the front side electrode layers 1X-4X has a band shape that expands in the left-right direction. The front side electrode layers 1X-4X are disposed parallel to each other while being spaced apart in the front-rear direction by a prescribed interval.

The front side wiring layers 1x-4x are electrically connected to the front side electrode layers 1X-4X via the front side through holes 310. Specifically, the front side wiring layer 1x is electrically connected to the front side electrode layer 1X; the front side wiring layer 2x is electrically connected to the front side electrode layer 2X; the front side wiring layer 3x is electrically connected to the front side electrode layer 3X; and the front side wiring layer 4x is electrically connected to the front side electrode layer 4X. As shown by black points in FIG. 1, when viewed from the upper side, front side contact points (contact points of the front side wiring layers 1x-4x and the front side electrode layers 1X-4X) are disposed on the radial inside of the front side through holes 310.

As shown in FIG. 4, the 16 front side constraint layers 32 are disposed between the upper surfaces of the 16 dielectric layers 2 and the lower surfaces of the four front side electrode layers 1X-4X. The front side constraint layers 32 and the dielectric layers 2 are disposed by the same number to obtain a one to one correspondence.

As shown in FIG. 3, the front side constraint layer 32 includes a constraint layer body 320, an inside adhesive layer 321, and an outside adhesive layer 322. The constraint layer body 320 is made from polyethylene terephthalate (PET) and has a shape of individual piece. The constraint layer body 320 expands and contracts more difficultly in the horizontal direction than the front side electrode layers 1X-4X and the dielectric layer 2. The upper surface of the inside adhesive layer 321 is fixed to the lower surface of the constraint layer body 320. The lower surface of the inside adhesive layer 321 is fixed to the upper surface of the dielectric layer 2. The lower surface of the outside adhesive layer 322 is fixed to the upper surface of the constraint layer body 320. The upper surface of the outside adhesive layer 322 is fixed to the lower surfaces of the front side electrode layers 1X-4X.

### Rear Side Electrode Unit 4

As shown in FIG. 2 and FIG. 3, the rear side electrode unit 4 is disposed on the lower side of the 16 dielectric layers 2. The configuration of the rear side electrode unit 4 is the same as the configuration of the front side electrode unit 3. That is, as shown in FIG. 5, the rear side electrode unit 4 includes a rear side base material 40, four rear side wiring layers 1y-4y, a rear side insulating layer 41, four rear side electrode layers 1Y-4Y, and 16 rear side constraint layers 42. The four rear side electrode layers 1Y-4Y are included in the concept of “electrode layer” of the disclosure. The 16 rear side constraint layers 42 are included in the concept of “constraint layer” of the disclosure.

The rear side base material 40 and the front side base material 30, the rear side wiring layers 1y-4y and the front side wiring layers 1x-4x, the rear side insulating layer 41 and the front side insulating layer 31, the rear side electrode layers 1Y-4Y and the front side electrode layers 1X-4X, and the rear side constraint layer 42 and the front side constraint layers 32 are respectively made of the same material.

As shown in FIG. 4 and FIG. 5, the laminated structure (the vertical arrangement) of the rear side electrode unit 4 is vertically symmetrical with the laminated structure of the front side electrode unit 3. That is, as shown in FIG. 5, on the upper side of the rear side base material 40, the rear side wiring layers 1y-4y, the rear side insulating layer 41, the rear side electrode layers 1Y-4Y, and the rear side constraint layer 42 are disposed from the lower side toward the upper side.

As shown in FIG. 5, four rear side through holes 410 are drilled in the rear side insulating layer 41. The four rear side through holes 410 vertically face the four rear side electrode layers 1Y-4Y. As shown in FIG. 1, when viewed from the upper side, the four rear side through holes 410 are lined up in the left-right direction to overlap on the front side electrode layer 1X of the first column from the front (the front side electrode layer closest to the connector 5).

As shown in FIG. 5, each of the rear side wiring layers 1y-4y includes a first wiring layer 43 and a second wiring layer 44. Each of the rear side electrode layers 1Y-4Y has a shape of band that expands in the front-rear direction. The rear side electrode layers 1Y-4Y are disposed parallel to each other while being spaced apart in the left-right direction by a prescribed interval.

The rear side wiring layers 1y-4y are electrically connected to the rear side electrode layers 1Y-4Y via the rear side through holes 410. Specifically, the rear side wiring layer 1y is electrically connected to the rear side electrode layer 1Y; the rear side wiring layer 2y is electrically connected to the rear side electrode layer 2Y; the rear side wiring layer 3y is electrically connected to the rear side electrode layer 3Y; and the rear side wiring layer 4y is electrically connected to the rear side electrode layer 4Y. As shown by black points in FIG. 1, when viewed from the upper side, rear side contact points (contact points of the rear side wiring layers 1y-4y and the rear side electrode layers 1Y-4Y) are disposed on the radial inside of the rear side through holes 410.

### Connector 5

As shown in FIG. 1, the connector 5 is disposed on the front side of the sensor sheet 1. The front side wiring layers 1x-4x and the rear side wiring layers 1y-4y are electrically connected to the connector 5 in a state that the front side wiring layers 1x-4x and the rear side wiring layers 1y-4y are mutually insulated.

### Detection Part, Non-Detection Part, Front Side Detection Path, and Rear Side Detection Path

As shown in FIG. 1, the front side electrode layers 1X-4X and the rear side electrode layers 1Y-4Y are lined up in a grid when viewed from the upper side. As shown by solid hatchings in FIG. 1, 16 detection parts A (1, 1)-A (4, 4) in all are set in overlapped portions of the front side electrode layers 1X-4X and the rear side electrode layers 1Y-4Y. Besides, in the detection part A (∘, Δ), “∘” corresponds to the front side electrode layers 1X-4X, and “Δ” corresponds to the rear side electrode layers 1Y-4Y.

As shown by one-dot dashed hatchings (dense) in FIG. 1, non-detection parts G are disposed between the detection parts A (1, 1)-A (4, 4). As shown in FIG. 2 and FIG. 3, a plurality of gaps g is partitioned in the non-detection parts G. The gaps g are disposed between the front side insulating layer 31 and the rear side electrode layers 1Y-4Y (for example, a point P1 of FIG. 1), between the front side electrode layers 1X-4X and the rear side insulating layer 41 (for example, a point P2 of FIG. 1), and between the front side insulating layer 31 and the rear side insulating layer 41 (for example, a point P3 of FIG. 1). The gaps g are disposed between an arbitrary pair of detection parts A (1, 1)-A (4, 4) which are adjacent in the horizontal direction (the front-rear direction, the left-right direction, and the direction diagonal to the front-rear direction and the left-right direction). The gaps g are disposed, for example, between the detection part A (1, 1) and the detection part A (1, 2), between the detection part A (1, 1) and the detection part A (2, 1), and between the detection part A (1, 1) and the detection part A (2, 2).

A front side detection path is set between an arbitrary detection part A (1, 1)-A (4, 4) and the connector 5. The front side detection path is set at least through the front side wiring layers 1x-4x. For example, as shown by a thick solid line in FIG. 1, a front side detection path B through part of the front side electrode layer 1X and the front side wiring layer 1x is set between the detection part A (1, 1) and the connector 5.

Similarly, a rear side detection path is set between an arbitrary detection part A (1, 1)-A (4, 4) and the connector 5. The rear side detection path is set at least through the rear side wiring layers 1y-4y. For example, as shown by a thick dotted line in FIG. 1, a rear side detection path C through the rear side wiring layer 1y only is set between the detection part A (1, 1) and the connector 5.

### Pressure-Sensitive Area and Pressure-Insensitive Area

The area in which the front side electrode layers 1X-4X and the rear side electrode layers 1Y-4Y are disposed (the area in which the detection parts A (1, 1)-A (4, 4) and the non-detection parts G are disposed) is a pressure-sensitive area D in which load can be detected. On the other hand, as shown by one-dot dashed hatchings (sparse) in FIG. 1, the area in which the front side electrode layers 1X-4X and the rear side electrode layers 1Y-4Y are not disposed (the area in which the connector 5, some of the front side wiring layers 1x-4x, and some of the rear side wiring layers 1y-4y are disposed) is a pressure-insensitive area E in which load cannot be detected. The pressure-insensitive area E encloses the pressure-sensitive area D in a frame shape from outside in the horizontal direction.

### Method for Manufacturing Sensor Sheet

Next, a method for manufacturing sensor sheet of this embodiment is described. The method for manufacturing sensor sheet of the embodiment includes a laminate production process, a rear side electrode unit attachment process, a front side electrode unit attachment process, and a connector mounting process.

In (a) of FIG. 6, a vertical cross-sectional view of a laminate is shown. In (b) of FIG. 6, a vertical cross-sectional view of a combination of the laminate (without a rear side mold-release base material) and the rear side electrode unit is shown. In (c) of FIG. 6, a vertical cross-sectional view of a combination of the laminate (without the rear side mold-release base material and a front side mold-release base material), the rear side electrode unit, and the front side electrode unit is shown.

As shown in (a) of FIG. 6, a laminate H includes 16 dielectric layers 2, 16 front side constraint layers 32, 16 rear side constraint layers 42, one front side mold-release base material 35, and one rear side mold-release base material 45. The front side mold-release base material 35 and the rear side mold-release base material 45 are respectively included in the concept of “mold-release base material” of the disclosure. The front side mold-release base material 35 and the rear side mold-release base material 45 are respectively made from PET.

In the laminate production process, the laminate H is produced. Specifically, firstly, the inside adhesive layer 321 of the front side constraint layer 32 is attached to the upper surface of the dielectric layer 2. In addition, an inside adhesive layer 421 of the rear side constraint layer 42 is attached to the lower surface of the dielectric layer 2. Next, the outside adhesive layer 322 of the front side constraint layer 32 is temporarily attached to the lower surface of the front side mold-release base material 35. In addition, an outside adhesive layer 422 of the rear side constraint layer 42 is temporarily attached to the upper surface of the rear side mold-release base material 45. In this way, a single laminate H is produced. In the laminate H, 16 “front side constraint layers 32-dielectric layer 2-rear side constraint layer 42” units are disposed corresponding to the 16 detection parts A (1, 1)-A (4, 4) of the sensor sheet 1 shown in FIG. 1.

In the rear side electrode unit attachment process, as shown in (b) of FIG. 6, firstly, the rear side mold-release base material 45 is detached from the outside adhesive layer 422. Next, the outside adhesive layer 422 is attached to the upper surface of the rear side electrode unit 4 (the portion other than the rear side constraint layer 42) which is produced in advance. Similarly, in the front side electrode unit attachment process, as shown in (c) of FIG. 6, firstly, the front side mold-release base material 35 is detached from the outside adhesive layer 322. Next, the outside adhesive layer 322 is attached to the lower surface of the front side electrode unit 3 (the portion other than the front side constraint layer 32) which is produced in advance. In the connector mounting process, the connector 5 shown in FIG. 1 is connected to a combination of the laminate H shown in (c) of FIG. 6, the rear side electrode unit 4, and the front side electrode unit 3. Besides, a chronological order of the rear side electrode unit attachment process and the front side electrode unit attachment process may be reversed (or simultaneous).

### Arrangement Method of Sensor Sheet

Next, an arrangement method of sensor sheet of this embodiment is described. In FIG. 7, a vertical cross-sectional view of the sensor sheet of the embodiment in an arrangement state is shown. In FIG. 8, an enlarged view in a frame VIII of FIG. 7 is shown. Besides, FIG. 7 corresponds to FIG. 2. FIG. 8 corresponds to FIG. 3.

As shown in FIG. 7, an arrangement surface 90 of an arrangement object 9 has a shape of curved-surface that projects upward. The sensor sheet 1 is fixed to the arrangement surface 90. Here, the shape (the curved-surface shape) of the arrangement surface 90 is different from the shape (the flat-surface shape) of the lower surface (the arrangement surface) of the sensor sheet 1 in a no-load state. Therefore, the sensor sheet 1 deforms from the flat-plate shape to the curved-plate shape that projects upward following the shape of the arrangement surface 90. A control part 6 is connected to the connector 5 of the sensor sheet 1.

When the sensor sheet 1 is disposed on the arrangement surface 90, the sensor sheet 1 deforms following the shape of the arrangement surface 90. Along with the deformation of the sensor sheet 1, a tensile stress is generated on the upper surface (the surface far from a curvature center) of the sensor sheet 1 as shown by an arrow Y1 in FIG. 8. On the other hand, a compressive stress is generated on the lower surface (the surface close to the curvature center) of the sensor sheet 1 as shown by an arrow Y2 in FIG. 8. Therefore, the tensile stress is generated in the front side electrode unit 3, and the compressive stress is generated in the rear side electrode unit 4.

Here, the plurality of gaps g is partitioned in the non-detection parts G. Therefore, when the tensile stress is generated, the front side electrode unit 3 (the portion of the front side electrode unit 3 in which the non-detection parts G are formed) expands easily in the surface direction. In addition, when the compressive stress is generated, the rear side electrode unit 4 (the portion of the rear side electrode unit 4 in which the non-detection parts G are formed) contracts easily (deflects easily) in the surface direction. Accordingly, when the sensor sheet 1 is disposed on the arrangement surface 9, the non-detection parts G can be made to deform prior to the detection parts A (1, 1)-A (4, 4) following the deformation of the sensor sheet 1.

In addition, the front side constraint layers 32 and the rear side constraint layers 42 are respectively disposed in the detection parts A (1, 4)-A (4, 4). Therefore, even if the tensile stress is generated, the front side electrode layers 1X-4X (the portions of the front side electrode layers 1X-4X in which the detection parts A (1, 1)-A (4, 4) are formed) do not easily expand in the surface direction. In addition, even if the compressive stress is generated, the rear side electrode layers 2Y do not contract easily in the surface direction. Accordingly, when the sensor sheet 1 is disposed on the arrangement surface 90, electrode area, that is, capacitance of the detection parts A (1, 1)-A (4, 4) can be suppressed from changing.

### Movement of Sensor Sheet

Next, a movement of the sensor sheet of this embodiment is described. Firstly, a voltage is applied to the front side electrode layers 1X-4X and the rear side electrode layers 1Y-4Y before a load is applied to the sensor sheet 1, and the capacitance is calculated for each of the detection parts A (1, 1)-A (4, 4). Subsequently, after a load is applied to the sensor sheet 1, the capacitance is also calculated for each of the detection parts A (1, 1)-A (4, 4). In the detection parts A (1, 1)-A (4, 4) of the portions to which the load is applied, a distance (a distance between electrodes) between the front side electrode layers 1X-4X and the rear side electrode layers 1Y-4Y is decreased. Therefore, the capacitance of the detection parts A (1, 1)-A (4, 4) is increased. Based on the change amount of the capacitance, the control part 6 detects the load for each of the detection parts A (1, 1)-A (4, 4). That is, the control part 6 measures a load distribution in the pressure-sensitive area D.

### Configuration of Capacitive Sensor

Next, a configuration of the capacitive sensor of this embodiment is described. In (a) of FIG. 9 and (b) of FIG. 9, transparent top views of the capacitive sensor including the sensor body (No. 1 or No. 2) cut off from the sensor sheet shown in FIG. 1 are shown. Besides, the front side wiring layers 1x-4x and the front side electrode layers 1X-4X are shown by solid lines; the rear side wiring layers 1y-4y and the rear side electrode layers 1Y-4Y are shown by dotted lines; and the front side contact points and the rear side contact points are shown by black points.

As shown in (a) of FIG. 9, the capacitive sensor 7 includes a band-shaped sensor body F cut off from the sensor sheet 1 and the control part 6. The sensor body F includes the detection parts A (1, 1)-A (1, 4), the connector 5, and the front side detection path and the rear side detection path for the detection parts A (1, 1)-A (1, 4). The control part 6 is electrically connected to the connector 5. The control part 6 measures the load distribution in the pressure-sensitive area D.

As shown in (b) of FIG. 9, the capacitive sensor 7 includes a step-shaped sensor body F cut off from the sensor sheet 1 and the control part 6. The sensor body F includes the detection parts A (1, 1)-A (1, 4), A (2, 1)-A (2, 3), A (3, 2), A (3,3), A (4, 2), the connector 5, and the front side detection path and the rear side detection path for the detection parts A (1, 1)-A (1,4), A (2,1)-A (2, 3), A (3, 2), A (3, 3), A (4, 2). Each of the detection parts A (1, 4) and A (4, 2) is partially cut off. The control part 6 corrects an electrical quantity (for example, voltage, current and the like) related to the capacitance of the detection part A (1, 4) corresponding to the electrode area of part of the front side electrode layer lx and part of the rear side electrode layers 4Y which constitute the detection part A (1, 4). Similarly, the control part 6 corrects an electrical quantity related to the capacitance of the detection part A (4, 2) corresponding to the electrode area of part of the front side electrode layers 4X and part of the rear side electrode layers 2Y which constitute the detection part A (4, 2). Besides, the arrangement method and movement of the capacitive sensor 7 are the same as the above-described arrangement method and movement of the sensor sheet 1.

### Operation Effect

Next, operation effects of the sensor sheet, the capacitive sensor, and the method for manufacturing sensor sheet of this embodiment are described. As shown in FIG. 2 and FIG. 3, the plurality of gaps g are partitioned in the non-detection parts G of the sensor sheet 1 of the embodiment. Therefore, as shown in FIG. 7 and FIG. 8, when the sensor sheet 1 is disposed on the arrangement surface 90 of the arrangement object 9, the non-detection parts G can be made to deform prior to the detection parts A (1, 1)-A (4, 4) following the shape of the arrangement surface 90. Accordingly, the detection parts A (1, 1)-A (4, 4) can be suppressed from deforming due to the arrangement state (the state in which the sensor sheet 1 is arranged on the arrangement surface 90) of the sensor sheet 1. Thus, capacitance of the detection parts A (1, 1)-A (4, 4) can be suppressed from changing due to the arrangement state of the sensor sheet 1.

In addition, as shown in FIG. 4, according to the sensor sheet 1 of the embodiment, the front side constraint layers 32 are respectively disposed in the detection parts A (1, 1)-A (4, 4). The front side constraint layers 32 are fixed to the dielectric layers 2 and the front side electrode layers 1X-4X (the portions of the front side electrode layers 1X-4X in which the detection parts A (1, 1)-A (4, 4) are formed). Therefore, when the sensor sheet 1 is disposed on the arrangement surface 90, the surface-direction expansion and contraction of the front side electrode layers 1X-4X and the dielectric layers 2 can be regulated. Accordingly, electrode area, that is, capacitance of the detection parts A (1, 1)-A (4, 4) can be suppressed from changing due to the arrangement state of the sensor sheet 1.

Similarly, as shown in FIG. 5, according to the sensor sheet 1 of the embodiment, the rear side constraint layers 42 are respectively disposed in the detection parts A (1, 1)-A (4, 4). The rear side constraint layer 42 are fixed to the dielectric layers 2 and the rear side electrode layers 1Y-4Y (the portions of the rear side electrode layers 1Y-4Y in which the detection parts A (1, 1)-A (4, 4) are formed). Therefore, when the sensor sheet 1 is disposed on the arrangement surface 90, the surface-direction expansion and contraction of the rear side electrode layers 1Y-4Y and the dielectric layers 2 can be regulated. Accordingly, electrode area, that is, capacitance of the detection parts A (1, 1)-A (4, 4) can be suppressed from changing due to the arrangement state of the sensor sheet 1.

In addition, as shown in FIG. 4 and FIG. 5, the 16 dielectric layers 2 are individually disposed with respect to the 16 detection parts A (1, 1)-A (4, 4). In addition, as shown in FIG. 2, the gap g is disposed between an arbitrary pair of detection parts A (1, 1)-A (4, 4) which are adjacent. Therefore, for example, even if a load is applied to the detection part A (2, 2) only and the detection part A (2, 2) deforms during use, the adjacent detection parts A (1, 2), A (3, 2), A (2, 1), A (2, 3), A (1, 1), A (1, 3), A (3, 1), A (3, 3) are not easily affected by the deformation. Accordingly, a detection accuracy of the load distribution is high.

In addition, the front side constraint layer 32 includes the inside adhesive layers 321 having adhesiveness. Therefore, the constraint layer body 320 and the dielectric layer 2 can be pasted easily. In addition, the front side constraint layer 32 includes the outside adhesive layer 322 having adhesiveness. Therefore, the constraint layer body 320 and the front side electrode layers 1X-4X can be pasted easily.

Similarly, the rear side constraint layer 42 includes the inside adhesive layer 421 having adhesiveness. Therefore, the constraint layer body 420 and the dielectric layer 2 can be pasted easily. In addition, the rear side constraint layer 42 includes the outside adhesive layer 422 having adhesiveness. Therefore, the constraint layer body 420 and the rear side electrode layers 1Y-4Y can be pasted easily.

In addition, in the no-load state shown in FIG. 2, a horizontal spring constant of the non-detection parts G (the portions in which the gaps g are partitioned) is set to 1, and a horizontal spring constant of the detection parts A (1, 1)-A (4, 4) is set to 2 or more and 50000 or less. Therefore, the detection parts A (1, 1)-A (4, 4) do not easily expand and contract in the horizontal direction with respect to the non-detection parts G. Accordingly, changes in electrode area can be suppressed even if the detection parts A (1, 1)-A (4, 4) expand and contract in the horizontal direction.

Besides, the reason for setting the horizontal spring constant of the detection parts A (1, 1)-A (4, 4) to 2 or more is that changes in electrode area (that is, changes in capacitance) caused by expansion of the front side electrode layers 1X-4X and the rear side electrode layers 1Y-4Y in the detection parts A (1, 1)-A (4, 4) are in an allowable range. For example, the spring constant can be achieved by making the front side constraint layer 32 and the rear side constraint layer 42 with an adhesive tape.

On the other hand, the reason for setting the horizontal spring constant to 50000 or less is that deterioration of a touch feeling at the time of touching the detection parts A (1, 1)-A (4, 4) or generation of a failure in the sensor sheet 1 is suppressed. For example, the spring constant can be achieved by making the front side constraint layer 32 and the rear side constraint layer 42 with a thin-layer PET film.

In addition, as shown in FIG. 1, (a) of FIG. 9 and (b) of FIG. 9, the sensor sheet 1 can be cut while securing the sensor body F. Particularly, when the sensor sheet 1 is cut along the non-detection parts G, the gaps g are partitioned in the non-detection parts G. Therefore, the sensor sheet 1 can be cut with a small cutting force. In addition, the front side constraint layers 32 and the rear side constraint layers 42 are not disposed in the non-detection parts G. From this point of view, the sensor sheet 1 can also be cut with a small cutting force.

In addition, as shown in (a) of FIG. 9 and (b) of FIG. 9, the sensor body F includes at least one of the detection parts A (1, 1)-A (4, 4), the connector 5, and the front side detection path B and the rear side detection path C for the detection part A (1, 1)-A (4, 4) (see FIG. 1). Therefore, the sensor body F having an arbitrary shape, that is, the capacitive sensor 7 can be cut off from the sensor sheet 1 having a prescribed shape or the like (the sensor sheet 1 which is shared and fixed in shape). Accordingly, even when a plurality of capacitive sensors 7 which are different in shape and the like are required, it is still unnecessary to design and produce a member exclusively used for the capacitive sensor 7 (for example, a printing plate in a case of producing the capacitive sensor 7 by printing, a mold in a case of producing the capacitive sensor 7 by molding and the like) one by one corresponding to the shape and the like of the desired capacitive sensor 7. That is, it is sufficient to cut off the sensor body F from the sensor sheet 1 corresponding to the shape and the like of the desired capacitive sensor 7. Therefore, the manufacturing cost of the capacitive sensor 7 can be reduced. Particularly, when a small-amount and large-variety of capacitive sensors 7 are manufactured, or when a prototype of the capacitive sensor 7 is manufactured, the manufacturing cost can be reduced.

In addition, as shown in FIG. 1, FIG. 2, FIG. 4 and FIG. 5, according to the sensor sheet 1 of the embodiment, the front side wiring layers 1x-4x are connected to the front side electrode layers 1X-4X from the upper side via the front side through holes 310. Similarly, the rear side wiring layers 1y-4y are connected to the rear side electrode layers 1Y-4Y from the lower side via the rear side through holes 410. Therefore, as shown in (a) of FIG. 9 and (b) of FIG. 9, undetectable detection parts A (1, 1)-A (4, 4) are not easily generated in the sensor body F after cut-off. Accordingly, the degree of freedom of the cut-off shape of the sensor body F can be increased.

In addition, as shown in FIG. 2, according to the sensor sheet 1 of the embodiment, the front side wiring layers 1x-4x and the front side electrode layers 1X-4X can be disposed to overlap vertically with the front side insulating layer 31 therebetween. Similarly, the rear side wiring layers 1y-4y and the rear side electrode layers 1Y-4Y can be disposed to overlap vertically with the rear side insulating layer 41 therebetween. Therefore, as shown in FIG. 1, a ratio (an area ratio) of the pressure-insensitive area E with respect to the entire sensor sheet 1 can be reduced. That is, as shown in (a) of FIG. 9 and (b) of FIG. 9, a ratio of the pressure-insensitive area E with respect to the entire sensor body F after cut-off can be reduced.

In addition, as shown in (b) of FIG. 9, according to the capacitive sensor 7 of the embodiment, when the sensor body F after cut-off has the detection parts A (1, 4) and A (4, 2) which are partially cut off, the control part 6 can correct an electrical quantity related to the capacitance of the detection parts A (1, 4) and A (4, 2). Therefore, the detection accuracy of the load distribution can be increased.

In addition, as shown in (a) of FIG. 6-(c) of FIG. 6, the method for manufacturing the sensor sheet 1 of the embodiment has the laminate production process. The laminate H includes 16 dielectric layers 2, 16 front side constraint layers 32, 16 rear side constraint layers 42, one front side mold-release base material 35, and one rear side mold-release base material 45. Therefore, the 16 dielectric layers 2, the 16 front side constraint layers 32, and the 16 rear side constraint layers 42 can be handled integrally. Accordingly, handling of the 16 dielectric layers 2, the 16 front side constraint layers 32, and the 16 rear side constraint layers 42 is simple. In addition, the front side mold-release base material 35 and the rear side mold-release base material 45 are both made from PET (resin). Therefore, the rigidity is high. Accordingly, the laminate H does not deform easily during handling.

### Second Embodiment

The sensor sheet, the capacitive sensor, and the method for manufacturing sensor sheet of this embodiment differ from the sensor sheet, the capacitive sensor, and the method for manufacturing sensor sheet of the first embodiment in that the front side constraint layers, the rear side constraint layers, and the dielectric layers are disposed not only in the detection parts but also in the non-detection parts. Here, only the difference is described.

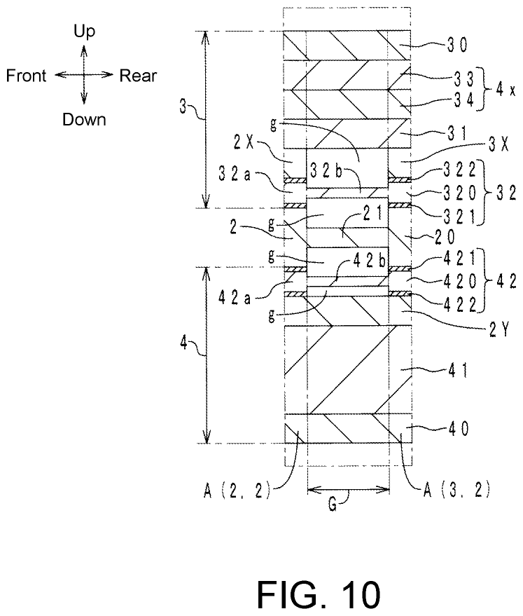

In FIG. 10, a vertical cross-sectional view of the vicinity of the non-detection parts of the sensor sheet of the embodiment is shown. Besides, the sections corresponding to FIG. 3 are shown by the same symbols. As shown in FIG. 10, in the non-detection part G between the pair of adjacent detection parts A (2, 2) and A (3, 2), a plurality of gaps g are partitioned across the vertical direction.

The dielectric layer 2 includes a plurality of detection part layers 20 and a plurality of non-detection part layers 21. The detection part layers 20 are disposed in the detection parts A (2, 2) and A (3, 2). The non-detection part layers 21 are disposed in the non-detection parts G. The non-detection part layers 21 couple a pair of detection part layers 20 which are adjacent. The non-detection part layers 21 are thinner in vertical direction than the detection part layers 20. In addition, in the no-load state, a pair of gaps g are partitioned on both sides in the vertical direction of the non-detection part layers 21. The non-detection part layers 21 are lower in rigidity than the detection part layers 20.

Similarly, the front side constraint layer 32 includes a plurality of detection part layers 32a and a plurality of non-detection part layers 32b. In addition, the rear side constraint layer 42 includes a plurality of detection part layers 42a and a plurality of non-detection part layers 42b. Configurations of the detection part layers 32a, 42a are the same as the configuration of the detection part layer 20. Configurations of the non-detection part layers 32b, 42b are the same as the configuration of the non-detection part layer 21.

In the sensor sheet, the capacitive sensor, and the method for manufacturing sensor sheet of this embodiment and the sensor sheet, the capacitive sensor, and the method for manufacturing sensor sheet of the first embodiment, the portions common in configuration have similar operation effects. In addition, according to the sensor sheet of the embodiment, the dielectric layers 2, the front side constraint layers 32, and the rear side constraint layers 42 are respectively formed integrally. Therefore, the number of components can be reduced. In addition, during the manufacturing of the sensor sheet, handling of the dielectric layers 2, the front side constraint layers 32, and the rear side constraint layers 42 is simple.

### Third Embodiment

The sensor sheet, the capacitive sensor, and the method for manufacturing sensor sheet of this embodiment differ from the sensor sheet, the capacitive sensor, and the method for manufacturing sensor sheet of the first embodiment only in the configuration of the front side wiring layer and the rear side wiring layer. Here, only the difference is described.

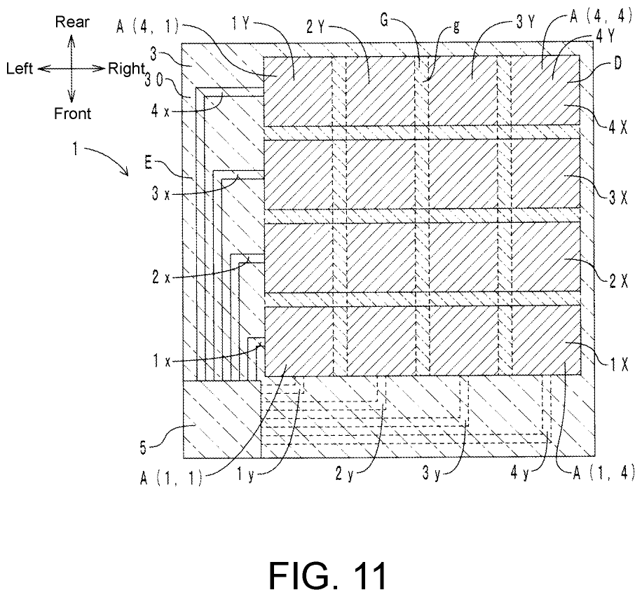

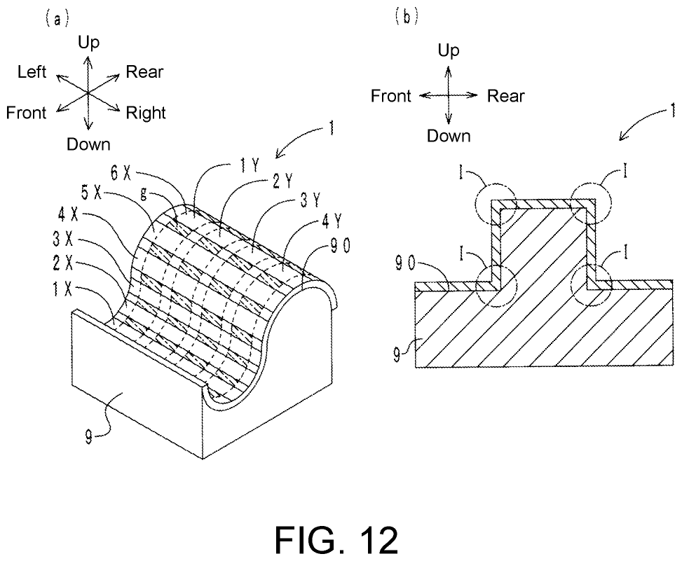

In FIG. 11, a transparent top view of the sensor sheet of the embodiment is shown. Besides, the sections corresponding to FIG. 1 are shown by the same symbols. As shown in FIG. 11, the front side wiring layers 1x-4x and the rear side wiring layers 1y-4y of the sensor sheet 1 are disposed in the pressure-insensitive area E. The front side wiring layers 1x-4x are connected to left ends of the front side electrode layers 1X-4X. In addition, the rear side wiring layers 1y-4y are connected to front ends of the rear side electrode layers 1Y-4Y.

In the sensor sheet, the capacitive sensor, and the method for manufacturing sensor sheet of this embodiment and the sensor sheet, the capacitive sensor, and the method for manufacturing sensor sheet of the first embodiment, the portions common in configuration have similar operation effects. Like the sensor sheet 1 of the embodiment, the front side electrode layers 1X-4X and the rear side electrode layers 1Y-4Y may be disposed so as to be staggered from the front side wiring layers 1x-4x and the rear side wiring layers 1y-4y in the surface direction.

### Alternative

The embodiments of the sensor sheet, the capacitive sensor, and the method for manufacturing sensor sheet of the disclosure are described above. However, the embodiment is not particularly limited to the above embodiments. The disclosure may also be implemented in various variants and modifications which can be made by the person skilled in the art.

In (a) of FIG. 12, an arrangement state diagram of the sensor sheet of another embodiment (No. 1) is shown. In (b) of FIG. 12, an arrangement state diagram of the sensor sheet of another embodiment (No. 2) is shown. As shown in (a) of FIG. 12, the shape of the arrangement surface 90 is not particularly limited. When the arrangement surface 90 has a shape of curved-surface, the curvature center may be on the upper side or the lower side of the sensor sheet 1. In addition, the curvature may change in the middle of the arrangement surface 90. In addition, the arrangement surface 90 is vertically curved along the front-rear direction (the expansion direction of the rear side electrode layers 1Y-4Y), but not vertically curved along the left-right direction (the expansion direction of the front side electrode layers 1X-6X). In this case, as shown by one-dot dashed hatchings in (a) of FIG. 12, the gaps g may be only disposed between the pair of detection parts which are adjacent in the front-rear direction. Similarly, when the arrangement surface 90 is vertically curved along the left-right direction but not vertically curved along the front-rear direction, the gaps g may be only disposed between the pair of detection parts which are adjacent in the left-right direction.

As shown in (b) of FIG. 12, corner parts I may be disposed on the arrangement surface 90. In this case, at least one of the constraint layers (the front side constraint layers 32 and the rear side constraint layers 42) and the gaps g may be disposed only in the portions of the sensor sheet 1 which correspond to the corner parts I.

The sensor sheet 1 shown in FIG. 1 and FIG. 11 and the sensor body F shown in (a) of FIG. 9 and (b) of FIG. 9 may include at least one of the front side constraint layer 32 and the rear side constraint layer 42. Similarly, the sensor sheet 1 shown in FIG. 1 and FIG. 11 and the sensor body F shown in (a) of FIG. 9 and (b) of FIG. 9 may include the gaps g in at least one of the front side electrode unit 3 and the rear side electrode unit 4.

The shapes of the sensor sheet 1 and the sensor body F in the no-load state shown in FIG. 2 and FIG. 3 are not particularly limited. The shapes may be flat-plate shapes or curved-plate shapes. Similarly, the shapes of the sensor sheet 1 and the sensor body F in the arrangement state shown in FIG. 7 and FIG. 8 are not particularly limited. The shapes may be flat-plate shapes or curved-plate shapes. In addition, when the sensor sheet 1 and the sensor body F are disposed on the arrangement surface 90 (when switched from the no-load state to the arrangement state), the sensor sheet 1 and the sensor body F may expand and contract in the surface direction. For example, a state of expanding or contracting horizontally with respect to the no-load state shown in FIG. 2 may be set as the arrangement state. In this case, the detection parts A (1, 1)-A (4, 4) of the sensor sheet 1 and the sensor body F can also be suppressed from deforming. Therefore, changes in capacitance of the detection parts A (1, 1)-A (4, 4) can be suppressed. Besides, when the sensor sheet 1 and the sensor body F are disposed on the arrangement surface 90, the shapes of the sensor sheet 1 and the sensor body F may not change at all.

The front side constraint layers 32 may be disposed between the front side insulating layer 31 and the front side electrode layers 1X-4X shown in FIG. 2. In this case, the horizontal expansion and contraction of the front side electrode layers 1X-4X can also be regulated. Similarly, the rear side constraint layers 42 may be disposed between the rear side insulating layer 41 and the rear side electrode layers 1Y-4Y shown in FIG. 2. In this case, the horizontal expansion and contraction of the rear side electrode layers 1Y-4Y can also be regulated.

The front side constraint layer 32 may not include the inside adhesive layer 321 and the outside adhesive layer 322. For example, a slip suppression part (being an uneven shape, an embossed shape or the like) may be arranged on the upper surface or the lower surface of the front side constraint layer 32, and the expansion and contraction of the dielectric layer 2 or the front side electrode layers 1X-4X is regulated by a frictional force. The same applies to the rear side constraint layer 42.

The sensor body F shown in (a) of FIG. 9 and (b) of FIG. 9 is produced by cutting the sensor sheet 1. The “cutting” includes “a form of cutting off (cutting away) the sensor body F from the sensor sheet 1”. That is, a form in which an area of the sensor body F after cutting is smaller than an area of the sensor sheet 1 before cutting is included. In addition, the “cutting” includes “a form of making a slit in the sensor sheet 1 (a form of not cutting off (not cutting away) the sensor body F from the sensor sheet 1)”. That is, a form in which the area of the sensor sheet 1 before cutting is equivalent to the area of the sensor body F after cutting is included.

The shape, position, arrangement number of structural components (for example, the dielectric layer 2, the front side base material 30, the front side wiring layers 1x-4x, the front side insulating layer 31, the front side electrode layers 1X-4X, the front side constraint layer 32, the rear side base material 40, the rear side wiring layers 1y-4y, the rear side insulating layer 41, the rear side electrode layers 1Y-4Y, the rear side constraint layer 42 and the like) of the sensor sheet 1 are not particularly limited.

For example, the arrangement number of the front side electrode layers 1X-4X and the arrangement number of the rear side electrode layers 1Y-4Y shown in FIG. 1 may be different. The shape, area and the like of the front side electrode layers 1X-4X and the shape, area and the like of the rear side electrode layers 1Y-4Y may be different. The intersection direction between the front side electrode layers 1X-4X and the rear side electrode layers 1Y-4Y is not particularly limited.

In addition, the arrangement number, shape, area and the like of the detection parts A (1, 1)-A (4, 4) shown in FIG. 1 are not particularly limited. A cut-off line showing the shape of the sensor body F (see (a) of FIG. 9 and (b) of FIG. 9) that can be cut may be disposed on the front surface and the rear surface of the sensor sheet 1. A cutting mark may remain on the outer edge of the sensor body F after cutting. A confirmation can be made by observing the cutting mark that the sensor body F is cut off from the sensor sheet 1.

The manufacturing method (the lamination method of each layer) of the sensor sheet 1 is not particularly limited. For example, various printing methods (for example, screen printing, inkjet printing, flexo printing, gravure printing, pad printing, lithography, transfer method and the like) may be used to laminate each layer.

The front side electrode layers 1X-4X, the front side wiring layers 1x-4x, the rear side electrode layers 1Y-4Y, and the rear side wiring layers 1y-4y may include elastomer and conductive materials from the point of view of being flexible and stretchable.

The front side base material 30, the rear side base material 40, the front side constraint layer 32, and the rear side constraint layer 42 are preferably resin films made from PET, polyethylene naphthalate (PEN), polyimide, polyethylene and the like, elastomer sheets, textiles (textile fabrics, knits, fabrics), and the like.

An elastomer or a resin (containing foam) with a relatively large dielectric constant may be used as the dielectric layer 2. For example, an elastomer or a resin with a dielectric constant of five or more (a measurement frequency of 100 Hz) is preferable. The elastomer includes urethane rubber, silicone rubber, nitrile rubber, hydrogenated nitrile rubber, acrylic rubber, natural rubber, isoprene rubber, ethylene-propylene copolymer rubber, butyl rubber, styrene-butadiene rubber, fluorine-contained rubber, epichlorohydrin rubber, chloroprene rubber, chlorinated polyethylene, chlorosulfonated polyethylene and the like. In addition, the resin includes polyethylene, polypropylene, polyurethane, polystyrene (including cross-linked expanded polystyrene), polyvinyl chloride, vinylidene chloride copolymer, ethylene-vinyl acetate copolymer, ethylene-vinyl acetate-acrylic acid ester copolymer and the like. The same applies to the material of the front side insulating layer 31 and the rear side insulating layer 41.

Applications of the sensor sheet and the capacitive sensor of the disclosure are not particularly limited. For example, the load distribution of a wound portion can be measured by winding the sensor sheet or the capacitive sensor on a desired portion (an arm part or the like) of a robot. In addition, the load distribution of a foot sole can be measured by laying the sensor sheet or the capacitive sensor on a shoe sole as an insole sensor.

What is claimed is:

1. A sensor sheet, comprising:
a pair of electrode layers disposed to be spaced apart in a lamination direction;
constraint layers that regulate the surface-direction expansion and contraction of the electrode layers;
a plurality of detection parts disposed in portions where the pair of electrode layers is overlapped when viewed from the lamination direction; and
non-detection parts disposed between the plurality of detection parts when viewed from the lamination direction,
wherein in a no-load state,
the constraint layers are disposed in at least some of the plurality of detection parts, and
gaps are partitioned in at least some of the non-detection parts.

2. The sensor sheet according to claim 1, comprising a plurality of dielectric layers which are disposed between the pair of electrode layers and are disposed in the plurality of detection parts.

3. The sensor sheet according to claim 2, wherein the constraint layers are disposed between the dielectric layers and the electrode layers.

4. The sensor sheet according to claim 3, wherein the constraint layers comprise constraint layer bodies, inside adhesive layers which adhere the constraint layer bodies to the dielectric layers, and outside adhesive layers which adhere the constraint layer bodies to the electrode layers.

5. The sensor sheet according to claim 1, wherein a surface-direction spring constant of portions of the non-detection parts in which the gaps are partitioned is set to 1, and
a surface-direction spring constant of portions of the detection parts in which the constraint layers are disposed is 2 or more and 50000 or less.

6. The sensor sheet according to claim 1, comprising:
a pressure-sensitive area in which the plurality of detection parts are set; and
a pressure-insensitive area which is disposed adjacent to the pressure-sensitive area in a surface direction, and which comprises an extraction part capable of extracting an electrical quantity related to the capacitance of the plurality of detection parts from outside.

7. The sensor sheet according to claim 6, wherein a portion of the sensor sheet which has the detection parts and the extraction part for the detection parts is set as a sensor body, and
the sensor sheet can be cut along the gaps while the sensor body is secured.

8. A capacitive sensor, comprising the sensor body of the sensor sheet according to claim 7.

9. A method for manufacturing sensor sheet, which manufactures the sensor sheet according to claim 4, the method comprising:
a laminate production process for producing a laminate which has the dielectric layers, the constraint layers and a mold-release base material by attaching the inside adhesive layers to the dielectric layers and temporally attaching the outside adhesive layers to the mold-release base material.
